(19) United States
(12) Patent Application Publication
(10) Pub. No.: US 2020/0276932 A1
(43) Pub. Date: Sep. 3, 2020

(54) ADAPTIVE LIGHTING DEVICE

(71) Applicant: GRUPO ANTOLIN-INGENIERIA S.A.U., Burgos (ES)

(72) Inventors: Antoine PIZETTI, Burgos (ES); Laurent DIEMUNSCH, Burgos (ES); Daniel ANDERLINI, Burgos (ES)

(21) Appl. No.: 16/646,676

(22) PCT Filed: Sep. 15, 2017
(86) PCT No.: PCT/ES2017/070615

§ 371 Date: Mar. 12, 2020

(51) Int. Cl. B60Q 3/20; F21V 14/06

(52) U.S. Cl. CPC B60Q 3/20; F21Y 2115/10; F21V 14/06

(57) ABSTRACT

In one embodiment a lighting device includes a support element, a light source mounted on the support element, the light source emitting a luminous beam in a first direction, a lens holder element, at least one lens mounted on the lens holder element, a motor mounted on the support element, an intermediate part for moving the lens holder element along the first direction, the intermediate part having first coupling means for coupling to the lens holder element, and second coupling means for coupling to the motor, and the motor being configured to act on the intermediate part in order to move the lens holder element between a first position in which the lens is closer to the light source and a second position in which the lens is farther from the light source inside the lighting device.

### TECHNICAL FIELD

The present invention relates to the sector of lighting, and more specifically, lighting devices for reading, especially for automobiles.

### BACKGROUND OF THE INVENTION

Lighting devices for vehicle interiors are known. The designs and structural characteristics of these lighting devices depend on the specific use and functionality thereof. These interior lights are especially applicable to vehicles, in which light requirements and conditions may vary from one moment to another, for example changing between ambient light, more or less diffuse and a more intense light for reading, and it may be necessary to individually adapt these conditions.

In the case of a vehicle, these lights are normally placed inside the vehicle, on the roof, and are configured to provide light to the passengers of the car, such that these lights are arranged above the passenger seats to individually provide light to each passenger.

These lights normally have a light source, a support for the light source, a lens and a connection to an electrical power source. In some cases, the support may pivot around a horizontal axis (for example, parallel to the roof of the vehicle); the support may also rotate around a vertical axis.

Patent document WO 2005/077714 describes an adjustable lighting assembly comprising a housing, a LED and a lens that is moveable between a spot lighting position and a flood lighting position. The lighting assembly has a structure formed by a gimbal mechanism (in turn formed by various elements), a support for the lens, as well as a latch mechanism with leaf springs. The adjustment of this lighting assembly must be made manually.

Therefore, it is necessary to provide a lamp for vehicle interiors with is self-adjustable regarding to the passengers needs in every moment, through an adjustable position of the lens that is simple and long-lasting.

### DESCRIPTION OF THE INVENTION

The invention relates to a lighting device according to claim 1. Preferred embodiments of the lighting device are defined in the dependent claims.

The lighting device of the present invention comprises:
a support element
a light source mounted on the support element, the light source emitting a luminous beam in a first direction, essentially vertical;
a lens holder element; and
at least one lens mounted on the lens holder element.

The support element serves as a base and position reference for the different elements of the lighting device, which is preferably mounted on a vehicle interior.

In the context of the present invention, lens is understood as any optical element capable of redirecting rays of light. It may be a single lens or several lenses arranged according to a specific configuration.

According to an aspect of the invention, the lighting device further comprises:
a motor mounted on the support element; and
an intermediate part for moving the lens holder element in the first direction, this intermediate part having first coupling means for coupling to the lens holder element, and second coupling means for coupling to the motor;
the motor being configured to act on the intermediate part in order to move the lens holder element inside the lighting device between a first position in which the lens is closer to the light source, the lighting device providing a wide light beam, and a second position in which the lens is farther from the light source, wherein the lighting device provides a narrow light beam.

The lighting device of the present invention as defined above provides an adjustable light beam by means of a simple configuration with the intermediate part actuated by a motor, capable of moving the lens inside the lighting device at least between two positions in which the lens-light source distance is different and a luminous beam of different characteristics is provided: a narrow, very focused beam (for example, suitable for reading) and a wide, poorly focused beam (suitable for general lighting).

In the context of the present invention, motor is understood as any means of electromechanical actuation capable of converting an electrical input into a mechanical output (for example, in linear movements or discrete angles). Preferably, this motor or means of actuation is electrically connected to a control, capable of adjusting the position of the lens, and consequently the light beam of the lighting device, either automatically depending on some parameters or by human activation, for example by means of a button, so that a user can remotely operate the motor, without having to directly act on the motor.

In some embodiments, the first coupling means of the intermediate part to couple to the lens holder element comprise a plurality of protrusions, the lens holder element comprising a plurality of helical grooves, each protrusion being configured to slide into a helical groove of the lens holder element. In this way, the protrusions of the moving part in the sliding thereof on the helical grooves provide a simple and solid way of converting the rotational movement of the intermediate part, actuated by the motor, into a linear motion of the lens holder element in the first direction.

In some embodiments, the second coupling means of the intermediate part for coupling to the motor comprise a toothed portion, configured to engage with an output element, such as a gearwheel, of the motor. In this way, simple coupling between the intermediate part and motor is achieved, in order to directly act on the lens holder. Furthermore, this coupling enables controlling the gear ratio between the toothed portion and the output element of the motor.

According to this proposed embodiment, the helical grooves have a shape (degree of inclination and length of the helix) that is determined by certain characteristics of the motor, such as the rotational speed thereof, and the gear ratio between the toothed portion and the output element of the motor. Thus, the parameters of the different elements may be chosen to ensure that passing from the first position to the second position is carried out within a set time.

In some embodiments, the support element comprises grooves and the lens holder element comprises guide elements configured to slide on said grooves, such that the lens holder element moves in the first direction. In this way, guiding of the lens holder element in the first direction is ensured. These grooves of the support element and the guiding elements of the lens holder element are preferably extended in the first direction.

In some embodiments, the support element further comprises tabs, preferably flexible for attaching the intermediate part; therefore, the intermediate part may have a ring-shaped projection along the outer surface thereof, or a series of discrete projections, arranged to correspond with the tabs of the support element, or one or several slots in which said tabs can be inserted. In this way, the position of the lens holder in the lighting device is fastened with respect to the support element.

In some embodiments, the lighting device further comprises a detection element for detecting that the lens holder element is in the first position in which the lens is closer to the light source. This detection element can be a mechanical or an electronic component.

In some embodiments, the intermediate part has a ring shape and the support element and the lens holder element consist in cylindrical bodies, according to the cinematics of the assembly.

In some embodiments, the light source comprises at least a LED diode; such that there is more free space to house the motor.

In some embodiments, the lighting device further comprises connection means connect to an electrical power source, such as a battery.

The different aspects and embodiments of the invention defined in the previous paragraphs may be combined together, provided that they are compatible.

Further advantages and characteristics of the invention will become apparent form the detailed description which follows and will be particularly indicated in the attached claims.

### BRIEF DESCRIPTION OF THE DRAWINGS

As a complement to the description, and for the purpose of helping to make the characteristics of the invention more readily understandable, in accordance with a practical embodiment thereof, said description is accompanied by a set of figures constituting an integral part thereof, which by way of illustration and not limitation represent the following:

FIG. 1 shows an upper exploded perspective view of the lighting device of the invention, with the main elements thereof.

FIG. 2 shows a lower perspective view of the lighting device of FIG. 1.

FIG. 3 shows an upper perspective view of the lighting device of FIG. 1, with the different mounted elements thereof.

FIG. 4 shows an upper perspective view of the lens holder.

FIG. 5 shows a lower perspective view of the lens holder.

### DESCRIPTION OF AN EXEMPLARY EMBODIMENT OF THE INVENTION

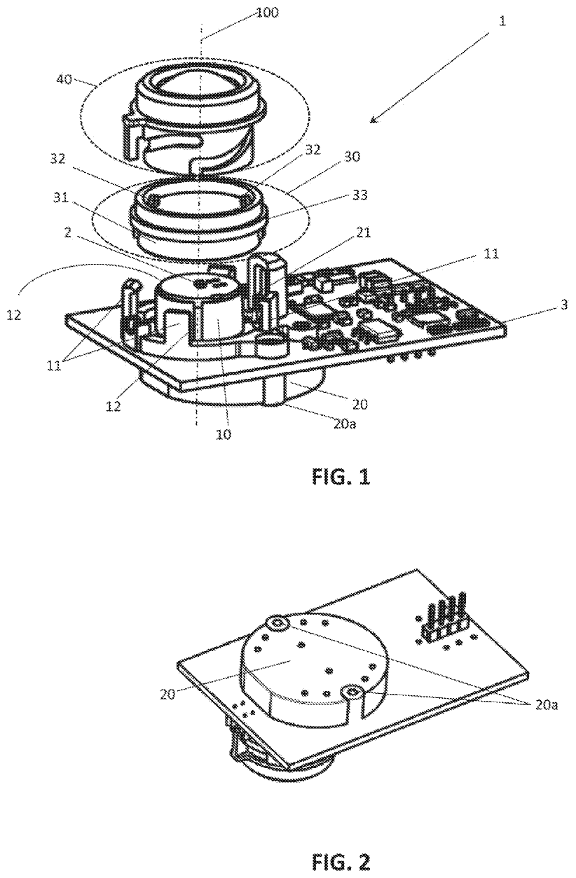

FIGS. 1-5, show a possible embodiment of the lighting device of the invention.

As shown in the exploded view of FIG. 1, the lighting device consists of a point or light 1, which, in accordance with the characteristics described below, provides an adjustable luminous light by means of a motorized system.

The light device 1 has a light source that in this case is a LED diode 2; however a combination of a plurality of LED diodes is possible.

The LED diode 2 is mounted on a support element 10 and emits light according to an essentially vertical direction 100. In this embodiment, the support element 10 is made of plastic (although it can also be made of metal), and is mounted on a motherboard 3, on which other electronic components are also mounted and through which the electrical power supply to the lighting device 1 is ensured. The lighting lamp 1 is placed on the inner roof of an automobile, preferably on the lining of the roof.

As can be seen in FIG. 1, the support element 10 also has tabs 11, as well as vertical grooves 12, the function of which is explained below. In the embodiment shown, the support element 10 has four tabs 11 and three vertical grooves 12, tabs and grooves distributed uniformly along the periphery of the support element 10. Of course, a different number of tabs and grooves is also possible, as well as a non-uniform distribution along the support element 10.

The lighting device 1 of the invention has a motor 20, that, as can better be seen in FIG. 2, is mounted inside the motherboard 3 and that in this case, is fastened to the support element 3 by means of screws 20a. Other known types of fastening, for example, rivets or adhesive, are also possible. The motor 20 can be an electric stepper motor, the output shaft of which has a gearwheel 21.

The lighting device 1 of the invention also has an intermediate part with a ring shape or crown 30, which in the example shown herein is also made of plastic material. The intermediate piece 30 has a toothed portion 31 on the inside thereof; this ring-shaped toothed portion is configured to engage with the gearwheel 21 of the motor 20. In the embodiment shown in the figures, the toothed portion 31 is on the outer surface of the intermediate piece 30, although there is also the possibility that this toothed portion 31 is on the inner surface of the intermediate piece 30, for which the position of the gearwheel 21 would be repositioned correspondingly.

On the other hand, the intermediate piece 30 has on the inner surface thereof protrusions 32 on the top of the intermediate piece 30. In the shown embodiment, the intermediate piece 30 has three protrusions distributed uniformly. Likewise, another number of protrusions and a non-uniform distribution is also possible.

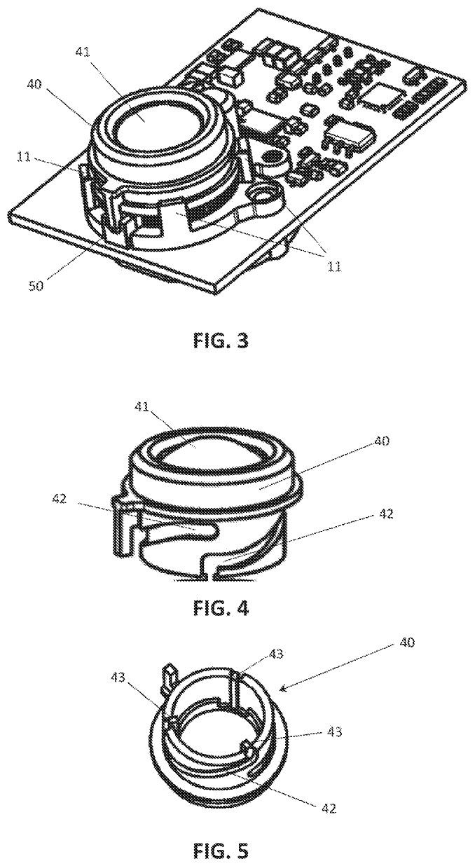

As can be better seen in FIG. 3, the intermediate piece 30 is fastened to the support element 10 by means of the plastic tabs 11 that fit around the intermediate piece 30 with a ring-shaped projection 33.

The lighting device 1 of the present invention further comprises a lens holder 40, in which one or more lenses 41 are mounted. As shown in FIG. 4, the lens holder 40 has helical grooves 42 on the outer surface thereof, which in the shown embodiment are three helical grooves 42. The lens holder 40 and the intermediate piece 30 are coupled by placing the protrusions 32 of the intermediate piece 30 in these helical grooves 42 of the lens holder 40.

The lens holder 40 also has on the inside thereof vertical guide elements 43, which are three in the shown embodiment.

The functioning of the adaptive lighting device of the invention is explained below.

When the motor 20 is operated by an on/off button (not shown), but electrically connected to the motor 20 by a wire or wirelessly and the gearwheel 21 is rotated, the latter in turn rotates the outer toothed portion 31 of the intermediate piece on the support element 10. The protrusions 32 of the intermediate piece 30 slide in the helical grooves 42 of the lens holder 40, making this lens holder 40 move in a translational movement along the vertical direction 100, guiding the vertical guide elements 43 of the lens holder 40 in the vertical grooves 12 of the support element 10. This translational movement of the lens holder 40 modifies the distance between the lens 41 (or the lenses, if there is more than one) with respect to the LED diode 2, which has the effect of modifying the light beam or cone of the light 1. When the lens 41 is close to the LED diode 2, the light beam is wide. When the lens 41 is far from the LED diode 2, the light beam is narrow.

The shape of the helical grooves 42 (inclination, length) is calculated based on the rotational speed of the motor 20 and the gear ratio between the gearwheel 21 of the motor 20 and the toothed portion 31 of the intermediate piece 30, to ensure that passing from the wide light beam position to the narrow light beam position is carried out in a specific period of time.

The motor 20 is controlled by an electronic control circuit, the motor being able to rotate in both directions of rotation to raise or lower the lens holder 40. In the case the motor 20 is a stepper motor, an end stroke stop element 50, is placed on support element 10, with the aim of stopping the movement of the lens holder 40 further from the end stroke, such that the control electronics of the motor is able to recognize when the lens 41 is this end stroke position, closer to the light source 2. In the case shown, a mechanical limit switch detection element is used, but it is also possible to implement this element with an electronic or optoelectronic component. Thus, the control electronics of the motor can detect the limit end stroke position of the lens holder 40 and also count the number of steps of the motor 20 to determine the exact position of the lens 41 with respect to the light source 2.

In the case of using another type of motor, the positions closest and farthest from the lens 41 with respect to the light source 2 can be managed by means of mechanical end stops, being detected by an increase in the consumption of the motor 20 when the lens holder 40 reaches these end stops placed at the end of the stroke.

In this text, the word “comprise” and its variants (such as “comprising”, etc.) should not be understood in an exclusive sense, i.e. they do not exclude the possibility of that which is described including other elements, steps, etc. Furthermore, the invention is not limited to the specific embodiments described, but rather it also encompasses, for example, variants that can be carried out by a person skilled in the art (for example, relating to the choice of material, dimensions, components, configuration, etc.), within the scope of what may be deduced from the claims.

What is claimed is:

1. A lighting device comprising:
a support element;
a light source mounted on the support element, the light source emitting a luminous beam in a first direction;
a lens holder element;
at least one lens mounted on the lens holder element; and
wherein the lighting device further comprises:
a motor mounted on the support element; and
an intermediate part for moving the lens holder element along the first direction, the intermediate part having first coupling means for coupling to the lens holder element, and second coupling means for coupling to the motor;
the motor being configured to act on the intermediate part in order to move the lens holder element between a first position in which the lens is closer to the light source and a second position in which the lens is farther from the light source inside the lighting device.

2. The lighting device according to claim 1, wherein the first coupling means of the part for coupling to the lens holder element comprise a plurality of protrusions, the lens holder element comprising a plurality of helical grooves, each protrusion being configured to slide into a helical groove of the lens holder element.

3. The lighting device according to claim 1, wherein the second coupling means for coupling to the motor comprise a toothed portion configured to engage with an output element of the motor.

4. The lighting device according to claim 2, wherein the helical grooves have a shape determined by some characteristics of the motor and the gear ratio between the toothed portion and the output element of the motor.

5. The lighting device according to claim 1, wherein the support element comprises grooves and the lens holder element comprises guide elements configured to slide on said grooves.

6. The lighting device according to claim 1, wherein the support element further comprises tabs for securing the intermediate part.

7. The lighting device according to claim 1, further comprising a detection element for detecting that the lens holder element is in the first position in which the lens is closer to the light source.

8. The lighting device according to claim 1, wherein the part has a ring shape and the support element and the lens holder element consist in cylindrical bodies.

9. The lighting device according to claim 1, wherein the part, the support element and/or the lens holder element are made of plastic material.

10. The lighting device according to claim 1, wherein the light source comprises at least one LED diode.

11. The lighting device according to claim 1 further comprising connection means for connecting to an electrical power source.

12. The lighting device according to claim 1, the lighting device being a light of an automobile.
